(19) United States
(12) Patent Application Publication
(10) Pub. No.: US 2005/0018231 A1
(43) Pub. Date: Jan. 27, 2005

(54) Print-setting device, print device and print-setting method

(75) Inventors: Nobuo Morimoto, Nagano-ken (JP); Kazuhiro Miyoshi, Nagano-ken (JP); Nobukazu Furutera, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/875,625

(22) Filed: Jun. 25, 2004

(30) Foreign Application Priority Data
Jun. 27, 2003 (JP) 2003-185150

(51) Int. Cl. G06F 15/00

(52) U.S. Cl. 358/1.13

(57) ABSTRACT

The present invention provides a print-setting device whose user interface is favorable from the perspective of operability and ease of viewing even when the user display space is limited, and a print device that comprises this print-setting device. The print-setting device comprises operating means which set print conditions, display means which display print-condition items and set print conditions, and control means which set print conditions based on operation of said operating means and control the display of said display means, wherein, in a first mode, a print condition corresponding to preset a settable item of all the print-condition items is able to be set by said operating means, and a print condition corresponding to an unsettable item except said settable item is set beforehand; and in a second mode, print conditions corresponding to all the print-condition items are able to be set by said operating means.

### BACKGROUND OF THE INVENTION

1. Field of the Invention

The present invention relates to a print-setting device for setting conditions for print processing and to a print device that comprises the print-setting device, and so forth, and, more particularly, to a print-setting device or similar capable of providing a favorable user interface.

2. Description of the Related Art

In view of the fact that, conventionally, it has not been possible to set print conditions unless a printer is connected to a personal computer, television screen, or the like, printers that are capable of printing by setting print conditions as a unit are being developed. Such printers are able to execute operations from data inputting to printing independently and are known as so-called stand-alone-type print devices. Stand-alone-type print devices have a function to allow image data recorded on a removable memory in a digital camera or the like to be printed without using a personal computer, and comprise means for setting the print conditions at this time.

As an example of such a print device, the printer disclosed in patent Publication No. 3,161,427 has been proposed. This printer comprises a display portion that displays print conditions and an input section for setting (selecting) print conditions in the main body of the printer. A user issues a print instruction after confirming, via the display portion, the print conditions set by using the input section. Further, the most recent of these stand-alone-type print devices allow the user to designate even advanced condition items during printing and comprise setting means that permit the user to set a multiplicity of print conditions.

However, although the above-mentioned conventional stand-alone-type print devices, which allow a multiplicity of print conditions to be set, are able to implement highly flexible printing that meets the demands of the user, the act of setting or confirming multiple print conditions is required each time printing takes place, and there has been the problem that the operation is therefore troublesome and there is the possibility of the wrong settings being made. It is known from experiments that the same user will often perform printing by means of the same conditions and the conventional user interface mentioned above needs to be improved also from this standpoint.

In addition, because there are also restrictions on the size of the display portion (display) that displays the print conditions in keeping with the miniaturization of print devices of recent years, a method that provides a scrolling display screen rather than displaying the whole multiplicity of print conditions at once (on one screen) has been adopted in many cases for conventional stand-alone-type print devices. Therefore, the user is required to perform a condition-setting operation as the screen is scrolled when printing, which has also posed a problem for conventional setting means.

Furthermore, a large display portion was adopted for the printer that appears in patent Publication No. 3,161,427, meaning that all the print conditions are displayed on one screen. However, this display constitution is inappropriate due to the above-mentioned trend toward miniaturization, and when the display portion is small and displayed entirely on the one screen, there is the problem that the letters are small and hard to see, and so forth.

### SUMMARY OF THE INVENTION

Therefore, an object of the present invention is to provide a print-setting device whose user interface is favorable from the perspective of operability and ease of viewing even when the user display space is limited, and a print device or the like that comprises this print-setting device.

In order to resolve the above object, an aspect of the present invention is a print-setting device comprising: operating means which set print conditions, display means which display print-condition items and set print conditions, and control means which set print conditions based on operation of said operating means and control the display of said display means, wherein: in a first mode, a print condition corresponding to preset a settable item of all the print-condition items is able to be set by said operating means, and a print condition corresponding to an unsettable item except said settable item is set beforehand; and in a second mode, print conditions corresponding to all the print-condition items are able to be set by said operating means. Therefore, according to the present invention, when printing accessible in the first mode is performed, there are few print-condition items set by the user, and, hence, the setting operation by the user can be kept simple.

In addition, according to a preferred embodiment of the invention, in said first mode, said display means display said settable item and the print condition for the item by means of one screen; and, in said second mode, said display means display said print-condition items and the print conditions for the items by means of a plurality of screens. As a result, in the first-mode case, there is no need to reference a plurality of screens when performing a setting operation and confirming the print conditions, and hence it is possible to provide a user interface that is easily seen and which is easy to operate.

Furthermore, according to a preferred embodiment of the invention, in said first mode, the print condition for said unsettable item is also displayed on said one screen displayed by said display means. Accordingly, in the first mode, the information required can be obtained via one screen.

Further, according to a preferred embodiment of the invention, the display area for said settable item displayed on said one screen is larger than the display area for said unsettable item. Accordingly, items that are to be set by the user in first mode can be-determined easily and the values set by the user himself/herself can be confirmed in a straightforward manner.

In addition, according to another embodiment of the invention, the display provided by said display means for said settable item in said first mode is larger than the display provided by said display means for each of said print-condition items in said second mode. Accordingly, in the first-mode case, it is possible to provide an interface that is easy for the user to understand and that makes it possible to prevent setting mistakes.

Furthermore, according to a preferred embodiment of the invention, in the event of a switching request between said first mode and said second mode using said operating means issued by the user, when said second mode is switched to said first mode, said display means provide a display that invites the user to confirm that the switch may be performed, and the mode switching is performed after a confirmation operation using said operating means performed by the user. As a result, the user performing printing under different conditions from the print conditions for unsettable items that are preset in the first mode can be prevented from making mistakes such as that of executing printing in the first mode in error.

In addition, according to another embodiment of the invention, the user is able to determine said settable item and said print condition that have been preset for said unsettable item in said first mode. Hence, a more convenient print-setting device can be provided because the user is able to customize the first mode with original content.

Furthermore, according to a preferred embodiment of the invention, said first mode has a plurality of modes whose said settable item or said print condition for said unsettable item is different from each other. As a result, it is possible to provide a print-setting device that is flexible and highly user-friendly.

Further, according to a preferred embodiment of the invention, when said second mode is selected, print conditions set on the previous occasion are set as default values for each of said print-condition items. As a result, the operation whereby the user sets the conditions can be reduced when the second mode is used, which facilitates the setting operation.

In order to achieve the above objects, another aspect of the present invention is that a print device comprises any of the above-mentioned said print-setting device; input means which input print-target data; and print means which execute printing based on the print conditions set by said print-setting device. As a result, it is possible to provide a print device that comprises a print-setting device with a favorable user interface.

In order to achieve the above objects, another aspect of the present invention is a print setting method comprising: a step of selecting a first mode or a second mode, a step of displaying a print-setting screen based on said selecting, and a step of setting print conditions with said print-setting screen, wherein: in a first mode, a print condition corresponding to preset a settable item of all the print-condition items is able to be set, and a print condition corresponding to an unsettable item except said settable item is set beforehand; and in a second mode, print conditions corresponding to all the print-condition items are able to be set.

Additional objects and characteristics of the present invention will become apparent from the embodiments of the invention described hereinbelow.

### BRIEF DESCRIPTION OF THE DRAWINGS

FIG. 1 is an external view of the print device according to the embodiment;

FIG. 2 is a block diagram showing the constitution of a print device 1;

FIG. 3 is a top view in which an operating panel 21 and a display 22 are shown enlarged;

FIG. 4 shows a display example of the display 22 in ‘basic mode’;

FIG. 5 illustrates the process in a case where printing is performed in ‘L-size’ mode;

FIG. 6 shows the screen transitions when the processing shown in FIG. 5 is executed;

FIG. 7 illustrates display screens in ‘customize mode’;

FIG. 8 shows the process when printing is performed in ‘favorite printing’ mode; and

FIG. 9 shows the screen transitions when the processing shown in FIG. 8 is executed.

### DESCRIPTION OF THE PREFERRED EMBODIMENTS

An embodiment of the present invention will be described hereinbelow with reference to the drawings. However, this embodiment does not limit the technological scope of the present invention. Further, the description is provided by assigning the same reference numerals or reference symbols to the same or similar elements in the drawings.

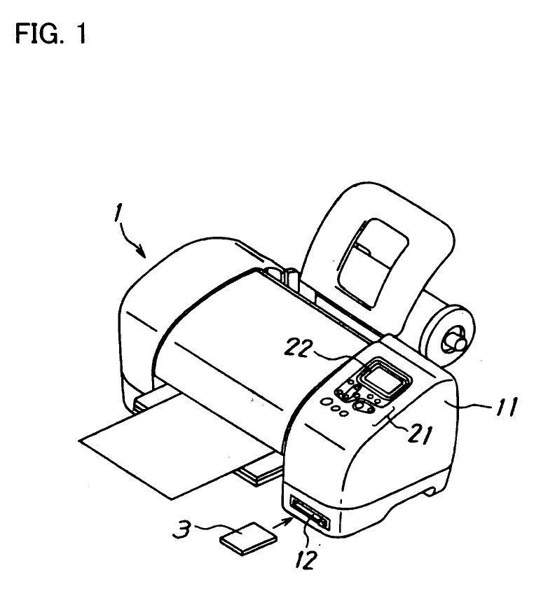

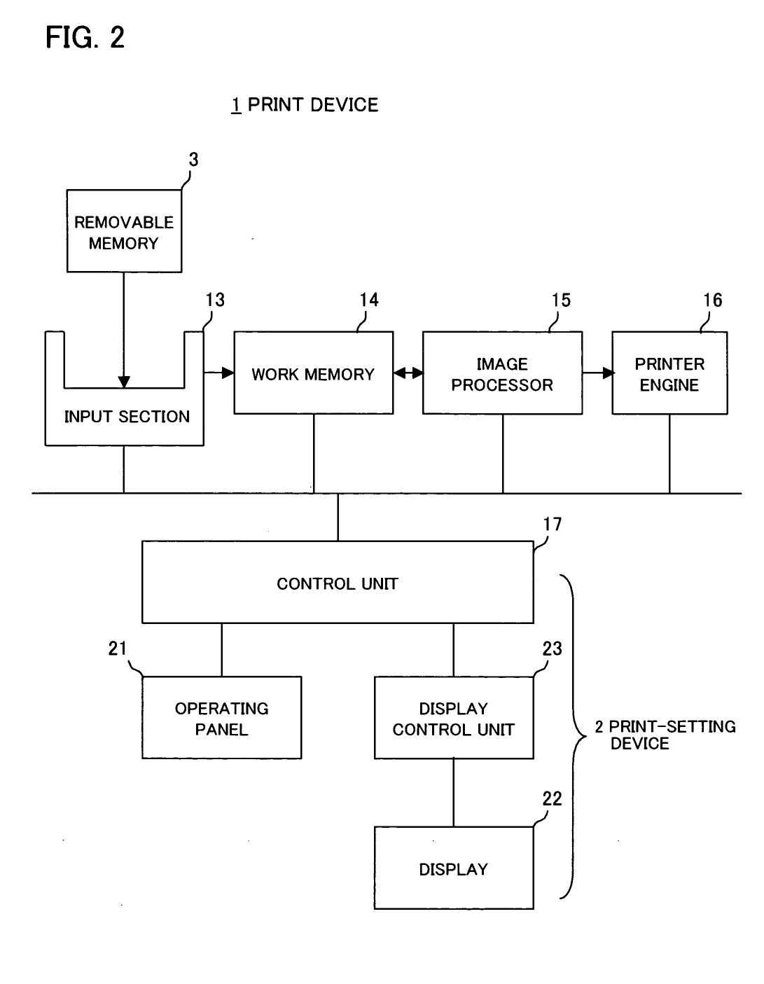

FIG. 1 is an external view of an embodiment of the print device that comprises the print-setting device to which the present invention is applied. As shown in FIG. 1, the print device 1 comprises a housing 11 that houses a power supply circuit, a control circuit, a drive circuit, an actuator, and so forth for printing. The card slot 12 shown in FIG. 1 is an opening for detachably connecting a removable memory 3 to an input section 13 described subsequently (See FIG. 2) that is provided in the housing 11. Further, the housing 11 is provided with a display 22 (display means), operating panel 21 (operating means), and so forth. The details will be described subsequently, but the user sets the print conditions by using the display 22 and operating panel 21, and so forth. The print device 1 according to this embodiment is characterized by a print-setting device 2 (See FIG. 2) that is constituted by the display 22, operating panel 21, and so forth and provides a user interface that is more favorable than a conventional user interface when setting the print conditions.

FIG. 2 is a block diagram showing the constitution of the print device 1. The removable memory 3 is a recording medium that can be mounted in and dismounted from the input section 13 (input means), and is, more specifically, a card-type flash memory that can be mounted in and dismounted from a digital camera, for example. The input section 13 is controlled by means of a control unit 17 and reads image data and so forth that is stored in the removable memory 3, storing this image data and so forth in a work memory 14.

An image processor 15 is a part that executes, in collaboration with the control unit 17, processing to convert the data stored in the work memory 14 into print data. The image processor 15 executes enlargement processing, gamma correction, color conversion processing, resolution conversion processing, half-tone processing, and so forth, on the image data stored in the work memory 14, for example. A printer engine 16 is controlled by the control unit 17 and forms images on printing paper based on print data that is generated by the image processor 15.

The control unit 17 is a part that controls the respective parts of the print device 1 and allows printing to be executed according to print conditions instructed by the user via the operating panel 21 (described subsequently). The control unit 17 is provided with a CPU and a ROM. A variety of control programs, various data and so forth are pre-stored on the ROM. The CPU controls the print device 1 by executing control programs that is stored on the ROM.

Next, the operating panel 21 is a part that performs an operation in order to allow the user to execute printing by means of the print device 1, and, more specifically, issues print-condition and print-start instructions. A signal that is input by means of the operating panel 21 operated by the user is analyzed by the control unit 17 and then reflected in the display of the display 22 and in the print processing that is carried out by the respective parts of the print device 1. Further, a plurality of switches is prepared for operation in the operating panel 21, the details of which will be provided subsequently.

The display 22 is the display portion of this print device 1 that displays the print-condition items, the content (conditions) set for these items, or the candidates that can be set for each item and so forth. The display 22 can be constituted by a liquid crystal panel, for example. A display control unit 23 is a part that controls the display on the display 22 based on instructions from the control unit 17.

As shown in FIG. 2, the print-setting device 2 for setting the print conditions, which is provided in this print device 1, is constituted by the operating panel 21, the display 22, the display control unit 23, and control unit 17, and so forth, and the print device 1 is characterized by the print-setting device 2 and hence this part will be described below.

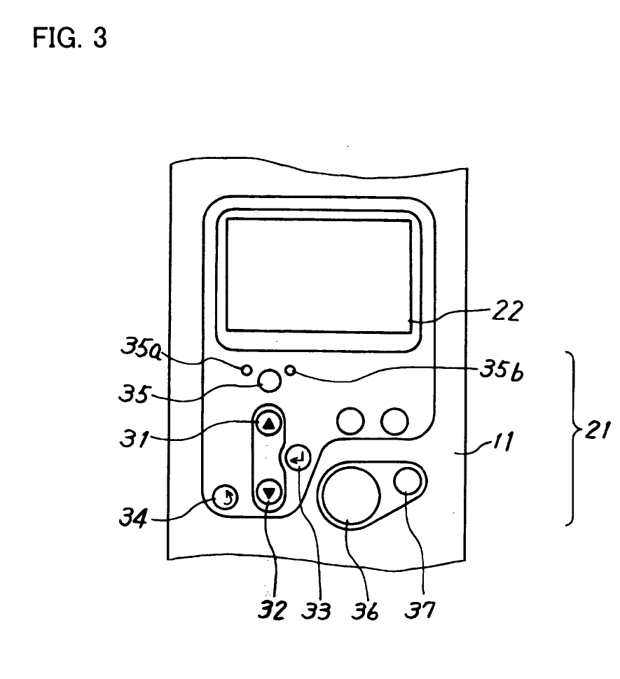

FIG. 3 is a top view in which the operating panel 21 and the display 22 of the printer 1 are shown enlarged. As stated earlier, the operating panel 21 and display 22 are provided in the housing 11 of the print device 1, and, as shown in FIG. 3, a plurality of switches is provided in the operating panel 21. Although not shown in FIG. 3, a menu for setting the print conditions is displayed on the display 22.

The switches that are prepared for the operating panel 21 are, as shown in FIG. 3, an Up switch 31, a Down switch 32, an OK switch 33, a Back switch 34, a mode-switching switch 35, a print start switch 36, a stop switch 37, and so forth. Of these switches, the Up switch 31, Down switch 32, OK switch 33, and Back switch 34 are switches for selecting menu items that are displayed on the display 22. Further, the print start switch 36 and stop switch 37 are a switch for issuing an instruction to start printing and a switch for issuing an instruction to stop printing respectively.

In addition, the mode-switching switch 35 is a switch for switching between two print-condition setting modes with which this print-setting device 2 is equipped. More specifically, the print-setting device 2 of this printer 1 is provided with a ‘basic mode’ (first mode), in which the setting items (settable items) that the user is able to select (set) are limited, and a ‘customize mode’ (second mode), in which the setting items are unlimited. The switch for switching between the two modes is the mode-switching switch 35. As shown in FIG. 3, two display lamps 35a, 35b are provided above the mode-switching switch 35. When the ‘basic mode’ is selected, the display lamp 35a lights up, and, when the ‘customize mode’ is selected, the display lamp 35b lights up.

Thus, the print-setting device 2 according to this embodiment comprises the ‘basic mode’, in which the user makes settings only with respect to items limited beforehand, and the ‘customize mode’, in which the user is able to make settings for all the items prepared for this print-setting device 2. The provision of these two modes and the fact that the display content of the display 22 differs between these two modes are the main characteristics. The ‘basic mode’ and ‘customize mode’ will be described in order below.

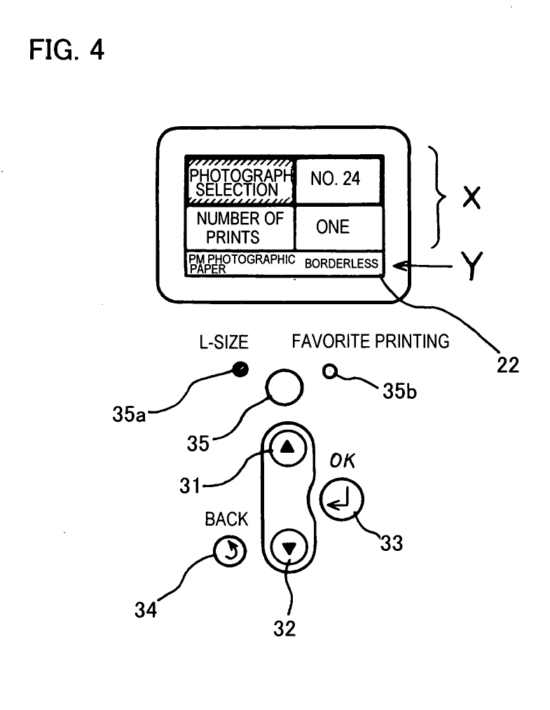

First, as stated earlier, ‘basic mode’ is a mode in which the print-condition items set by the user when performing printing are limited, and is a so-called easily setting mode. FIG. 4 shows a display example of the display 22 in ‘basic mode’. Further, in FIG. 4, the display 22 and part of the operating panel 21 are shown.

As shown above the display lamps 35a and 35b in FIG. 4, in the example shown in FIG. 4, the ‘basic mode’ is known as ‘L size’ and the ‘customize mode’ is called ‘favorite printing’. Further, the ‘L size’, which is the ‘basic mode’, is an easy mode when printing photographic data that is recorded in the removable memory 3, and is a mode in which the user sets only two items, namely the photograph (number) to be printed and the number of prints, and in which print conditions are preset for the other print-condition items (unsettable items), that is, for the paper type, paper size, layout, and so forth. More specifically, in the ‘L-size’ mode, the paper type is fixed as “PM photograph paper”, the paper size as “L size”, and the layout as “borderless”. On the other hand, ‘favorite printing’ mode is a mode in which the user is able to set all the available setting items and will be described subsequently. ‘L-size’ mode is described as an example of ‘basic mode’ hereinbelow.

As shown in the display 22 in FIG. 4, in ‘L-size’ mode, two items that are set by the user, that is, ‘photograph selection’ and ‘number of prints’, are displayed at the top (the X section in FIG. 4), and the preset content for the ‘paper type’ and ‘layout’, which cannot be set by the user, that is, “PM photographic paper” and “borderless”, are displayed below these user-set items (the Y section in FIG. 4). Further, the fact that the ‘paper size’ is “L size” is not displayed because this fact is clear from the name of the mode.

Here, although the ‘photograph selection’ item in the display 22 is displayed inverted in FIG. 4, this indicates a state where this item has been selected by the user. Further, the example displayed in FIG. 4 represents a state where ‘photograph selection’ and ‘number of prints’ have been set as “number 24” and “one” respectively.

Further, this ‘L-size’ mode (basic mode) is characterized in that the screen displayed on the display 22 is one screen. That is, although the specific set content of ‘photograph selection’ and ‘number of prints’ varies, in ‘L-size’ mode, only the display screen shown in FIG. 4 is prepared and the user performs a print-setting operation via this one screen alone. Stated differently, the information required when print settings are made is mostly included on the displayed screen.

In addition, in ‘L-size’ mode (basic mode), the two items set by the user, that is ‘photograph selection’ and ‘number of prints’ are displayed as large items, and the preset content is displayed as small items as shown in FIG. 4. The fact that the display area for the items set by the user is larger than the display area for the preset content is one characteristic of this print-setting device 2. Further, because FIG. 4 represents an ‘L-size’ mode (basic mode) case, the display lamp 35a is lit.

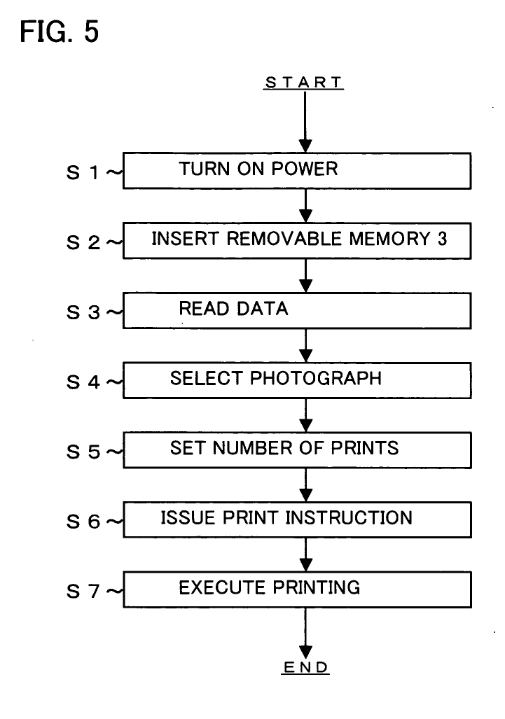

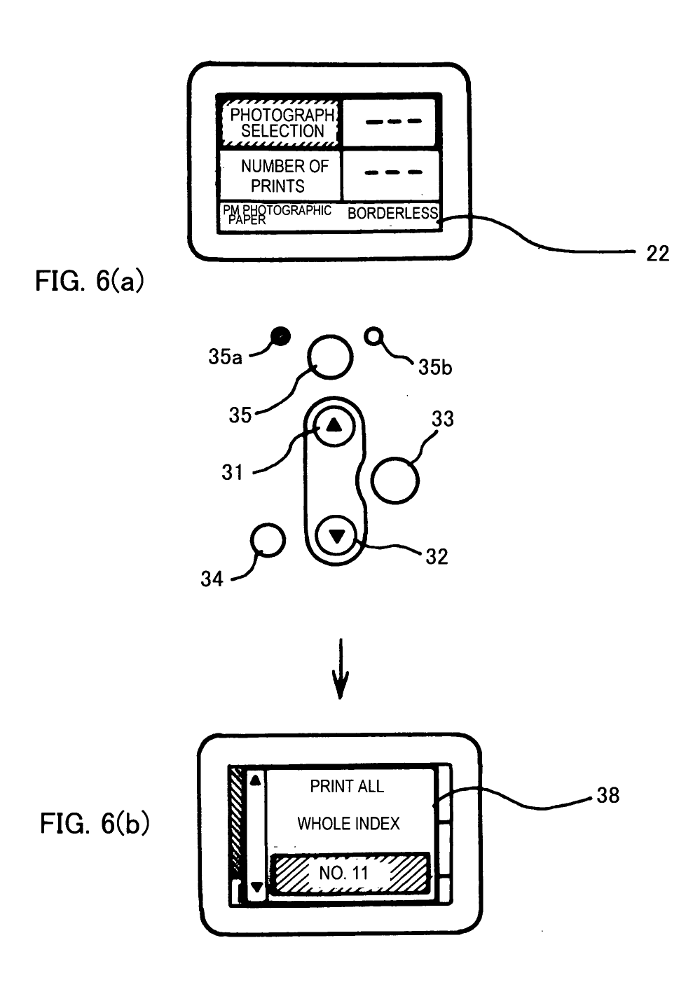

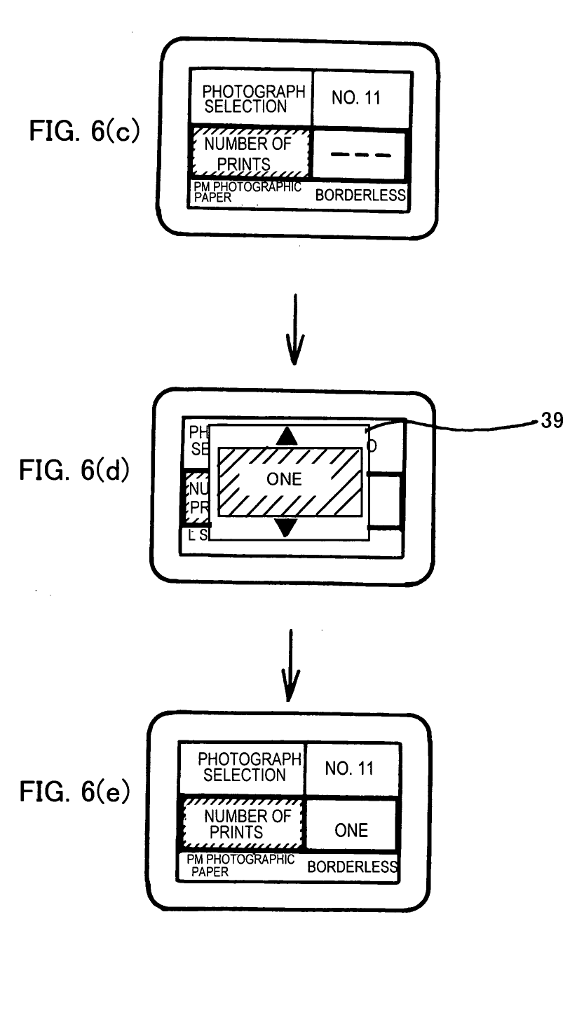

FIG. 5 is a flowchart that illustrates the process in a case where printing is performed in ‘L-size’ mode (basic mode). Further, FIG. 6 shows the transitions of the screen displayed on the display 22 when the processing shown in FIG. 5 is executed. First, the user turns on the power of the print device 1 (step S1 in FIG. 5). Next, the user inserts the removable memory 3 storing the photographic data to be printed in the card slot 12 of the print device 1 (step S2 in FIG. 5).

When the removable memory 3 is inserted, the print device 1 reads the image data stored in the removable memory 3 to the work memory 14 (step S3 in FIG. 5). Thereafter, the ‘L-size’ mode (basic mode) print-setting screen is displayed on the display 22 by means of the control unit 17 and the display control unit 23. FIG. 6(a) illustrates the start screen. As shown in FIG. 6(a), the start screen is a display in which the items ‘photograph selection’ and ‘number of prints’, which are to be set by the user, have not yet been provided. Further, in the start screen, for ‘photograph selection’, the photograph with the largest number among the photographic data stored in the removable memory 3, or the number of the photograph taken most recently may be displayed as the default value, while “1” may be displayed as the default value for the ‘number of prints’. Since there are frequent cases where the user normally prints one new photo at a time, the user operation can be simplified by setting such default values.

Next, the user selects the photograph to be printed via the start screen (step S4 in FIG. 5). More specifically, in the start screen shown in FIG. 6(a), the item ‘photograph selection’ has been selected, and hence the OK switch 33 on the operating panel 21 is pressed. Accordingly, the signal is transmitted to the control unit 17 and the photograph selection menu 38 as shown in FIG. 6(b) is displayed on the display 22 by means of the control unit 17 and the display control unit 23. In addition to the number of each photograph stored in the removable memory 3, a menu that includes “print all” for selecting all the photographs, “print range” for selecting a plurality of consecutive photographs, and “select and print” for selecting a plurality of photographs and then selecting the number of prints for each selected photograph are prepared for the photograph selection menu 38. Here, supposing that photograph “No. 11” is selected, the user selects “No. 11” in the photograph selection menu 38 by using the Up switch 31 and Down switch 32 on the operating panel 21, and then presses the OK switch 33. The photograph-selection operation therefore ends and the control unit 17 identifies that “No. 11” is the print target, and, as shown in FIG. 6(c), the screen enters a state where ‘photograph selection’ is “No. 11” and the item ‘number of prints’ is selected for the next operation. Further, during this photograph selection, the photographs may be selected after checking the photograph content by using a photographic-data display monitor, which is not illustrated in FIG. 1 and so forth.

Next, the user sets the number of prints for the selected photograph (step S5 in FIG. 5). More specifically, in the state shown in FIG. 6(c), the OK switch 33 is pressed. Accordingly, the print-number selection menu 39 shown in FIG. 6(d) is displayed on the display 22. Therefore, the desired number of prints is selected by means of an operation like the case in the photograph selection menu 38. In this example, “1” is selected and the OK switch 33 is pressed. Accordingly, ‘number of prints’ is determined as “1”, and the display of the display 22 enters the state shown in FIG. 6(e).

Therefore, the operation performed by the user in setting the print conditions ends, and hence the user identifies the set content by means of the display 22 (screen shown in FIG. 6(e)) and issues a print instruction provided if there are no errors (step S6 in FIG. 5). More specifically, the print start switch 36 of the operating panel 21 is pressed. Further, when the set content is to be changed before the print instruction, the item that has been changed by using the Up switch 31 and Down switch 32 on the operating panel 21 on the display 22 (screen shown in FIG. 6(e)), that is, ‘photograph selection’ or ‘number of prints’, is selected and the settings are corrected by means of the above-mentioned operation.

When the print start switch 36 is pressed, the control unit 17 instructs each part of the print device 1 to perform printing under the set conditions, and, finally, printing on the medium in the printer engine 16 is executed (step S7 in FIG. 5). Further, in the example shown in FIG. 6, photograph No. 11 is printed once without a border on L-size PM photographic paper.

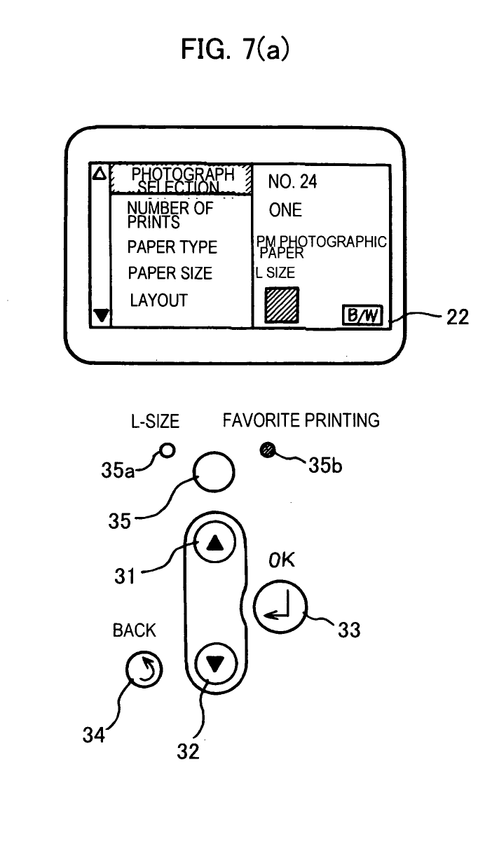

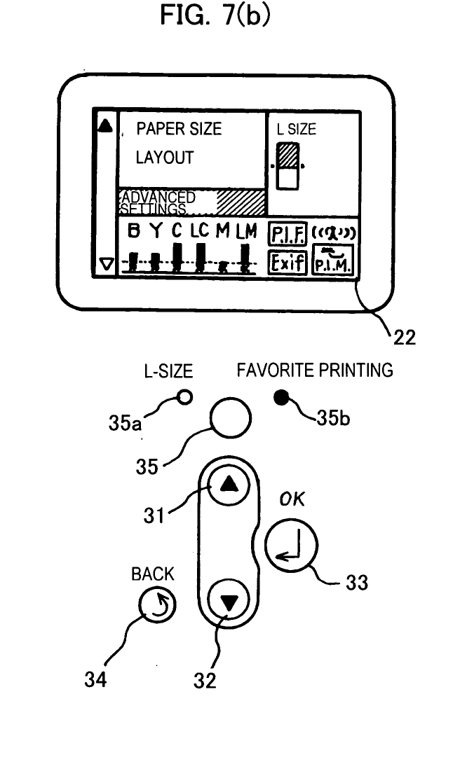

Next, the ‘favorite printing’ mode, which is the ‘customize mode’, is described. As mentioned earlier, this is a mode that allows the user to set all the items prepared for this print-setting device 2. FIG. 7 shows a display example for the display 22 in ‘favorite printing’ mode (‘customize mode’). FIG. 7(a) shows the first-page screen and FIG. 7(b) shows the second-page screen. Thus, in ‘favorite printing’ mode, multiple items are set by the user and the display 22 has only a limited display space. The print setting screen is thus prepared to span two screens.

In the print-setting screen shown in FIG. 7(a) and FIG. 7(b), the items on the left-hand side represent the print-condition items to be set, while the information on the right-hand side indicates content that is set for each item. The display area on the display 22 of each set item is smaller than the display area for ‘photograph selection’ and ‘number of prints’ of ‘L-size’ mode (basic mode) illustrated in FIG. 4. Further, the illustration of FIG. 7 represents the ‘favorite printing’ mode case and hence display lamp 35b is lit.

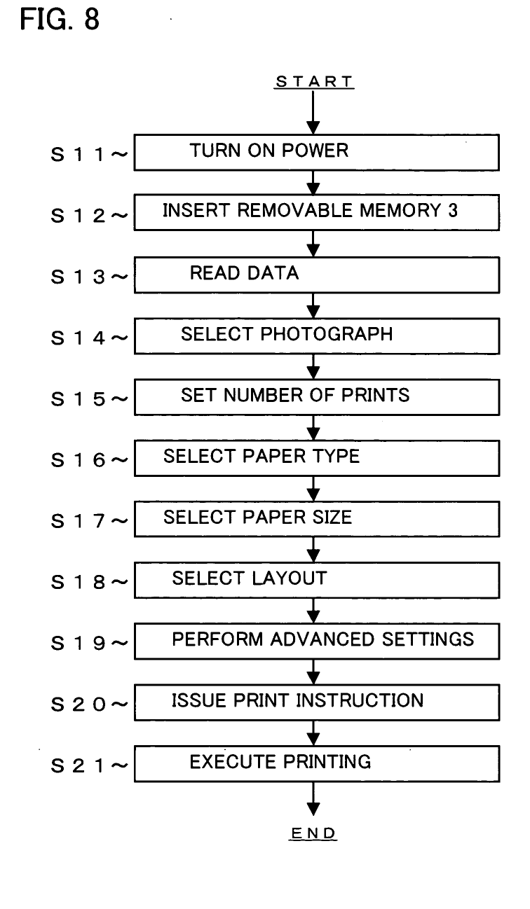

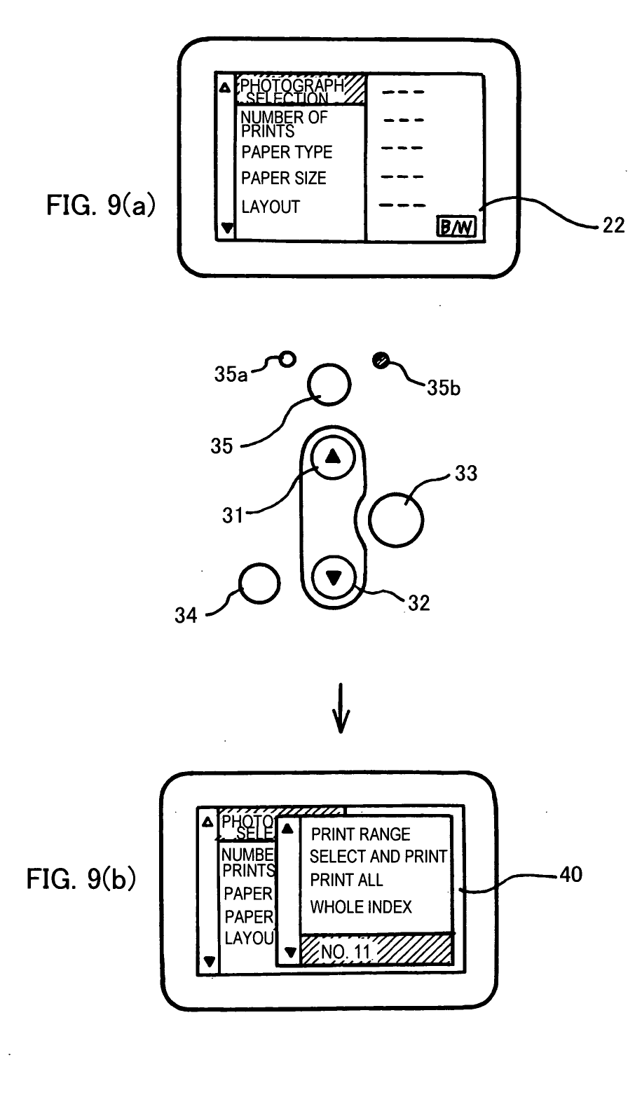

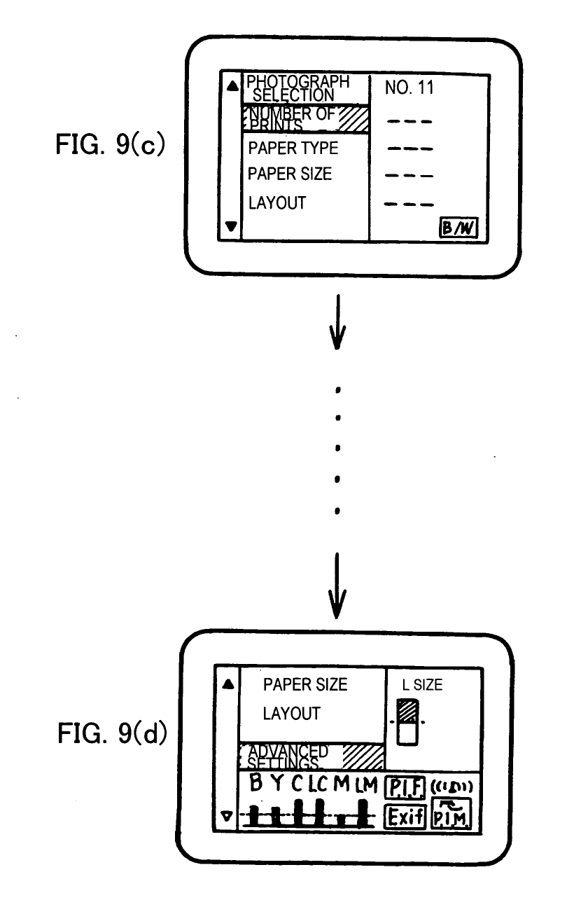

FIG. 8 is a flowchart illustrating the process when printing is performed in ‘favorite printing’ mode (‘customize mode’). Further, FIG. 9 shows the screen transitions displayed on display 22 when the processing shown in FIG. 8 is executed. First, as per the ‘L-size’ mode (basic mode) case, the user turns on the power of print device 1 (step S11 in FIG. 8) and inserts the removable memory 3 in the card slot 12 (step S12 in FIG. 8).

The print device 1 reads data in the removable memory 3 thus inserted (step S13 in FIG. 8) and displays the ‘favorite printing’ mode setting screen on the display 22. For example, the start screen shown in FIG. 9(a) is displayed. Here, the setting operation has not yet been performed and, hence, although the set content is not displayed on the right-hand side of the display screen, the default values may be displayed. The displayed default values may be values determined beforehand and prepared for the print device 1 or may be the values of the print conditions for the printing executed on the previous occasion. In cases where printing is executed successively a plurality of times under printing conditions that are different from the standard print conditions, the operation with the latter default values is more straightforward.

Next, the user selects the photographs to be printed (step S14 in FIG. 8). The specific operating method is as per the ‘L-size’ mode (basic mode) case and involves the selection and determination of the desired photograph from the photograph selection menu 40 shown in FIG. 9(b). In this example, “No. 11” is selected, and hence the screen enters the state shown in FIG. 9(c). Thereafter, settings are made for the items ‘number of prints’, ‘paper type’, ‘paper size’, ‘layout’, and ‘Advanced settings’ by means of a similar operation (steps S15 to S19 in FIG. 8). A menu similar to the photograph selection menu 40 is prepared for the setting of each item. As per the ‘photograph selection’ case, settings are made by selecting desired items from the selection displayed on the menu.

When settings have been completed for all the print conditions above, the user checks the set content via the display 22 (screen shown in FIG. 9(d), or similar), and, as long as no mistakes have been made, issues a print instruction (step S20 in FIG. 8). More specifically, the print start switch 36 of the operating panel 21 is pressed. Further, when the set content is to be changed before the print instruction, the settings are corrected by means of a procedure similar to the ‘L-size’ mode (basic mode) case. When the print start switch 36 is pressed, the control unit 17 instructs each part of the print device 1 to perform printing under the set conditions, and, finally, the printing by the printer engine 16 on the medium is executed (step S21 in FIG. 8).

As described above, the print-setting device 2 of the print device 1 comprises ‘basic mode’ and ‘customize mode’, and the user switches between and uses these modes according to the application. This mode-switching is executed by pressing the mode-switching switch 35 on the operating panel 21 mentioned earlier. Further, when the mode-switching switch 35 is pressed, the printer 1 displays a message that allows the user to confirm whether the mode may actually be switched on the display 22, and, as a result of the user performing an operation indicating that the mode may be switched, mode-switching is executed. The operation performed by the user to indicate that the mode may be switched, that is, the operation of confirming mode-switching, is performed by means of the Up switch 31, Down switch 32, and OK switch 33, and so forth, of the operating panel 21.

Further, the displaying of the confirmation message for this mode-switching and the confirmation operation may be performed only when switching from ‘customize mode’ to ‘basic mode’. Furthermore, when switching from ‘customize mode’ to ‘basic mode’, the displaying of the mode-switching confirmation message and the confirmation operation may be performed only when there is a difference between the content set in ‘customize mode’ for the preset items that cannot be set by the user in ‘basic mode’, and the content of ‘basic mode’. More specifically, when switching from ‘favorite printing’ to ‘L size’, in cases where, in ‘favorite printing’, no settings have been made to set “PM photographic paper” as the paper type, “L size” as the paper size, and “borderless” as the layout, the displaying of the confirmation message for mode-switching and the confirmation operation are performed. Thus, because confirmation of mode-switching is executed, printing when the user has made setting mistakes can be prevented.

As described above, the print device 1 according to this embodiment comprises a print-setting device 2 that is equipped with ‘basic mode’ and ‘customize mode’, and it is possible to switch between and use the two modes according to the application. Therefore, when printing suited to ‘basic mode’ is performed, that is, when printing is performed under the print conditions determined beforehand in ‘basic mode’, by using ‘basic mode’, there are very few items to be set by the user, meaning that the setting of print conditions can be performed by means of a simple operation. In addition, because there are few items set by the user, setting mistakes are reduced.

Furthermore, as stated earlier, in ‘basic mode’, the print-condition settings screen is one screen, and the user is able to see, via this screen, all the user-set items as well as the items that have been determined beforehand. Therefore, the settings are completed without scrolling the screen and performing the act of confirming the settings via a plurality of screens, and hence it is possible to provide a user interface via which the setting operation is straightforward and which is easy for the user to see.

In addition, as illustrated in FIG. 4, the settings screen in ‘basic mode’is such that the print conditions to be set by the user are displayed larger than the predetermined conditions and it can therefore be said that this is a display that is easy to understand both from the point of view of the user identifying the items to be set and from the perspective of confirming the content that he or she has set himself/herself. Therefore, based on these facts, it is possible to provide an interface that is easy for the user to operate and that makes it possible to prevent setting mistakes.

Further, by specifically rendering the ‘basic mode’ the ‘L-size’ mode mentioned earlier, that is, by rendering a mode in which the paper type is fixed as “PM photographic paper”, the paper size is fixed as “L size” and the layout is fixed as “borderless”, and in which only the selection of photographs and the setting of the number of prints is performed by the user, the photograph printing that is generally performed the most often is permitted by means of a straightforward operation and the effects of providing ‘basic mode’ are considerable.

On the other hand, ‘customize mode’ is also prepared for the print device 1 and therefore printing under print conditions that are different from ‘basic mode’ and printing in which the advanced print conditions are different, and so forth, are naturally possible, which makes it possible to provide the user with a flexible printing environment.

Further, in the example above, ‘basic mode’ is the ‘L-size’ mode, and the content of this mode is fixed. However, the content of the ‘basic mode’ may be rendered to allow changes to be made by the user. To put this another way, an environment in which ‘basic mode’ can be customized may be provided. For example, in the printing of photographs, users who perform printing on a “postcard” more than printing in “L size” are able to use ‘basic mode’ after changing the paper size among the print conditions that are predetermined in ‘basic mode’ to “postcard”.

In addition, the content of ‘basic mode’ can be stored in the print device 1 in the form of a plurality of patterns and one of the patterns may be selected and used according to requirements. For example, the following three patterns are stored and used properly according to the application.
(Pattern 1) [Fixed] L size, PM photographic paper, borderless [set] photograph number, number of prints;
(Pattern 2) [Fixed] Postcard, PM photographic paper, with border [set] photograph number, number of prints;
(Pattern 3) [Fixed] A4, regular paper, standard [set] file number, number of units.

In the above descriptions of each pattern, ‘[fixed]’ indicates a pre-determined condition, and [set] indicates an item set by the user. For example, pattern 3 is ‘basic mode’, which is used when standard printing is performed by selecting the desired file from among data files such as documents recorded in the removable memory 3. The user is able to execute standard printing on A4 regular paper simply by setting the number of the file to be printed and the number of units. The content of a plurality of such patterns may be set in print device 1 beforehand, or the user may be able to register and change this content in accordance with requirements.

Therefore, by rendering ‘basic mode’ customizable and making it possible to employ ‘basic mode’ of a plurality of patterns, it is possible to provide a print device that is flexible and highly convenient.

Further, the print-setting device 2 described above was provided in the print device 1 but the print-setting device can also be constituted separate from the print device. For example, a digital camera may comprise a similar print-setting device. In this case, a display, operating panel, control unit, and so forth similar to those of the print-setting device 2 can be provided in the digital camera, and the print conditions can be set by the digital camera. The set conditions are stored in a removable memory together with the photographic data and are read to and used by the print device. Generally, because it is not possible to secure a considerably large display space in the case of a digital camera either, the provision of ‘basic mode’ by using the print-setting device according to the present invention is significant.

The scope of protection of the present invention is not limited to or by the above embodiments and instead covers the inventions appearing in the claims as well as any equivalents thereof.

1. A print-setting device comprising:
operating means which set print conditions,
display means which display print-condition items and set print conditions, and
control means which set print conditions based on operation of said operating means and control the display of said display means,
wherein:
in a first mode, a print condition corresponding to preset a settable item of all the print-condition items is able to be set by said operating means, and a print condition corresponding to an unsettable item except said settable item is set beforehand; and
in a second mode, print conditions corresponding to all the print-condition items are able to be set by said operating means.

2. The print-setting device according to claim 1, wherein:
in said first mode, said display means display said settable item and the print condition for the item by means of one screen; and,
in said second mode, said display means display said print-condition items and the print conditions for the items by means of a plurality of screens.

3. The print-setting device according to claim 2, wherein, in said first mode, the print condition for said unsettable item is also displayed on said one screen displayed by said display means.

4. The print-setting device according to claim 3, wherein the display area for said settable item displayed on said one screen is larger than the display area for said unsettable item.

5. The print-setting device according to claim 1, wherein the display provided by said display means for said settable item in said first mode is larger than the display provided by said display means for each of said print-condition items in said second mode.

6. The print-setting device according to claim 1, wherein:
in the event of a switching request between said first mode and said second mode using said operating means issued by the user,
when said second mode is switched to said first mode,
said display means provide a display that invites the user to confirm that the switch may be performed, and the mode switching is performed after a confirmation operation using said operating means performed by the user.

7. The print-setting device according to claim 1, wherein the user is able to determine said settable item and said print condition that have been preset for said unsettable item in said first mode.

8. The print-setting device according to claim 1, wherein:
said first mode has a plurality of modes whose said settable item or said print condition for said unsettable item is different from each other.

9. The print-setting device according to claims 1, wherein:
when said second mode is selected, print conditions set on the previous occasion are set as default values for each of said print-condition items.

10. A print device, comprising:
said print-setting device according to any one of claims 1 to 9;
input means which input print-target data; and
print means which execute printing based on the print conditions set by said print-setting device.

11. A print setting method comprising:
a step of selecting a first mode or a second mode,
a step of displaying a print-setting screen based on said selecting, and
a step of setting print conditions with said print-setting screen,
wherein:
in said first mode, a print condition corresponding to preset a settable item of all the print-condition items is able to be set, and a print condition corresponding to an unsettable item except said settable item is set beforehand; and
in said second mode, print conditions corresponding to all the print-condition items are able to be set.
